(19) United States
(12) Patent Application Publication
(10) Pub. No.: US 2009/0327704 A1
(43) Pub. Date: Dec. 31, 2009

(54) STRONG AUTHENTICATION TO A NETWORK

(75) Inventor: Kristjan E. Hatlelid, Sammamish, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/147,653

(22) Filed: Jun. 27, 2008

(51) Int. Cl. H04L 9/00

(52) U.S. Cl. 713/156

(57) ABSTRACT

Embodiments for providing strong authentication to a network from a networked device are disclosed. In accordance with one embodiment, a method for authentication to a server includes sharing a session key between the networked device and the server. The method further includes sending an encrypted secret key that is encoded based on the session key to a memory of the networked device. The also method includes sending original data to the networked device for encryption into encrypted data using the secret key. The method additionally includes decrypting the encrypted data received from the networked device using the secret key to obtain decrypted data for comparison with the original data for determining access to networked resources.

### BACKGROUND

Strong authentication, or multiple-factor authentication, is a system of computer security that validates the identities of networked users via a combination of authentication methods. For example, strong authentication may include the use of user name and password in conjunction with an authentication certificate. The use of the authentication certificate may involve the use of hardware authentication devices or software authentication tokens stored in hardware devices. However, due to the need for specialized authentication hardware and software support, strong authentication may be expensive to deploy. Thus, strong authentication that involves the use of authentication devices has generally not been accepted by consumers and the public.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Described herein are embodiments of various technologies for implementing strong authentication to a network for access to networked resources. In one embodiment, a method for authentication to a server includes sharing a session key between the networked device and the server. The method further includes sending an encrypted secret key that is encoded based on the session key to a memory of the networked device. The also method includes sending original data to the networked device for encryption into encrypted data using the secret key. The method additionally includes decrypting the encrypted data received from the networked device using the secret key to obtain decrypted data for comparison with the original data for determining access to networked resources. Other embodiments will become more apparent from the following detailed description when taken in conjunction with the accompanying drawings.

### BRIEF DESCRIPTION OF THE DRAWINGS

The detailed description is described with reference to the accompanying figures. In the figures, the left-most digit(s) of a reference number identifies the figure in which the reference number first appears. The use of the same reference number in different figures indicates similar or identical items.

FIG. 1 is a block diagram illustrating an exemplary network environment on which strong authentication to networked resources are implemented in accordance with various embodiments.

FIG. 2A is a block diagram illustrating an exemplary procedure for issuing a networked device that is capable of storing the one or more authentication credentials as encrypted data to a user, in accordance with various embodiments.

FIG. 2B is a block diagram illustration an exemplary procedure for providing a networked device with authentication credentials, in accordance with various embodiments.

FIG. 3A is a block diagram illustrating selected components of an exemplary networked device that is capable of data encryption, as implemented on the network environment shown in FIG. 1, in accordance with various embodiments.

FIG. 3B is a block diagram illustrating selected components of an exemplary authentication server that is configured to enable authentication via an encryption algorithm-equipped networked device, as implemented on the network environment shown in FIG. 1, in accordance with various embodiments.

FIG. 4A is a flow diagram illustrating an exemplary process for storing an encrypted secret on an encryption algorithm-equipped networked device, as implemented on the network environment shown in FIG. 1, in accordance with various embodiments.

FIG. 4B is a flow diagram illustrating an exemplary process for authentication to access networked resources using the encrypted secret, as implemented on the network environment shown in FIG. 1, in accordance with various embodiments.

FIG. 5A is a flow diagram illustrating an exemplary process for storing authentication data on an encryption algorithm-equipped networked device, as implemented on the network environment shown in FIG. 1, in accordance with various embodiments.

FIG. 5B is a flow diagram illustrating an exemplary process for authentication to access networked resources using the authentication data, as implemented on the network environment shown in FIG. 1, in accordance with various embodiments.

FIG. 6 is a block diagram illustrating a representative computing device. The representative device may be a part of the network environment show in FIG. 1, in accordance with various embodiments.

### DETAILED DESCRIPTION

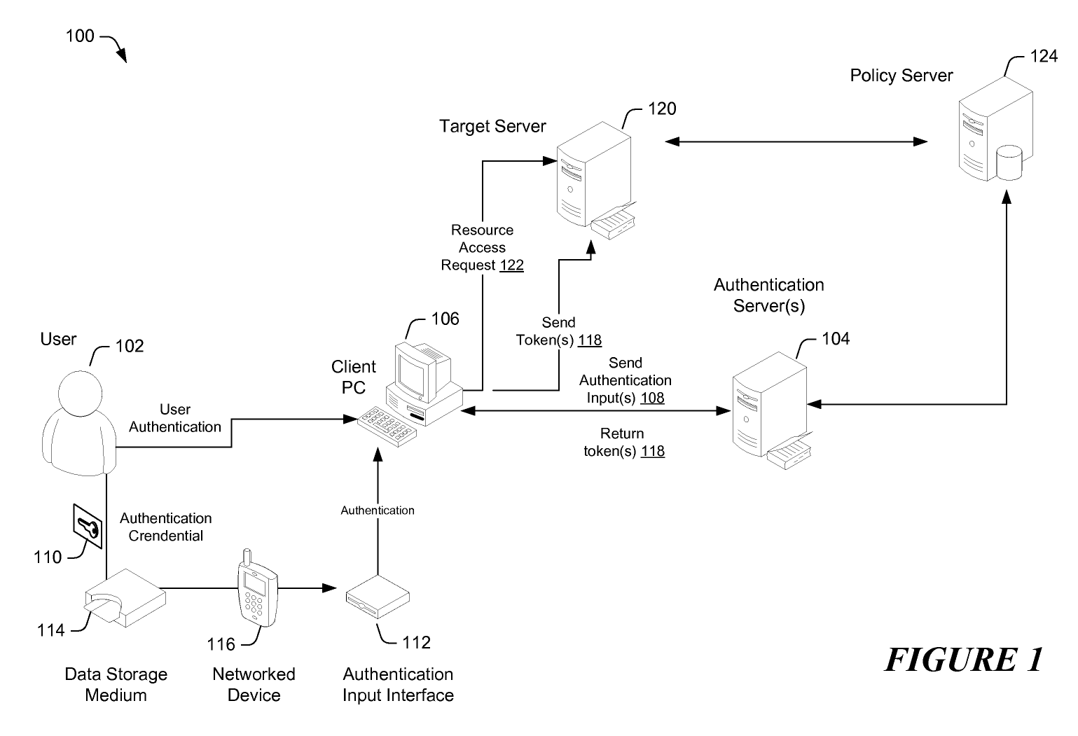

This disclosure is directed to embodiments that facilitate strong authentication to networked resources via an encryption algorithm-equipped networked device. Specifically, the embodiments described herein are directed to using the encryption algorithm in the networked device to store encrypted data that are needed to authenticate to a server. The encrypted data may include authentication data and encryption keys. In various examples, the encrypted data stored on networked device is secured against viewing and/or duplication by the encryption algorithm. In this way, embodiments of the present disclosure provide strong authentication for accessing computing resources, while protection for valuable or sensitive networked resources is simultaneously increased. Various examples of strong authentication to networked resources via the use of encryption algorithm-equipped networked devices are described below with reference to FIGS. 1-6.

### Exemplary System Architecture

FIG. 1 illustrates an exemplary network environment 100 that enables strong authentication to networked resources via the use of networked devices that are equipped with encryption algorithms. For example, a networked device may store an encryption algorithm in its memory. The encryption algorithms may be configured to protect encryption keys and authentication data that are used to authenticate to a server for access to computing resources. The network environment 100 enables a user 102 to authenticate the user's identity to an authentication server 104, or, alternatively, one or more authentication servers 104, via a client PC 106. The network environment 100 may include at least one of a wide-area network (WAN), a local area network (LAN), and the like. The authentication servers 104 may control access to the entire network or, alternatively, control access to a particular domain on the network. In various instances, the authentication server 104 may include domain controllers.

During strong authentication, the user 102 may initiate authentication by providing an authentication input 108 to the authentication server 104. The authentication input 108 may be in the form of a logon identity and a password. The authentication process may continue with the user 102 providing one or more additional authentication credentials 110, as issued to the user 102, to the authentication server 104. For example, the additional authentication credential may include a secret data key that validates the user to the authentication server. In other embodiment, the authentication credential may include a variety of other proof of identity information, such as smart card-based public key infrastructure (PKI) authentication certificates and one or more associated cryptographic keys, or one-time use passphrases. The user 102 may submit the additional authentication credential 110 to an authentication input interface 112 that is connected with the client PC 106.

Accordingly, the authentication input interface 112 may be configured to communicate with a data storage medium 114 that contains the additional authentication credential 110. The authentication credential 110 may be stored as encrypted data on the data storage medium 114. In various instances, the data storage medium may be a Secure Digital (SD) card. In turn, the authentication input interface 112 may be a SD card reader capable of retrieving information from the SD card. Furthermore, the authentication credential 110 may be converted into encrypted data by the Cryptomeria cipher (C2) algorithm present on the SD card. In some instances, the data storage medium 114 may be installed into or an integral part of a networked device 116. The networked device 116 may include, but is not limited to, personal digital assistants (PDAs), smart phones, Universal Serial Bus (USB) dongles, or the like. The networked device 116 may include a wireless interface that enables it to interact with the authentication input interface 112. By example, but not limitation, the wireless interface may include a wireless radio frequency (RF) interface (e.g., cellular, Personal Communication Service (PCS), Wireless Fidelity (WiFi), Ultrawideband, Bluetooth, satellite transmissions, etc.), an infrared interface, and the like. In other examples, the networked device 116 and the authentication input interface 112 may be configured to communicate via a wired interface. The wired interface may include, but is not limited to, a direct I/O interface, such as a LAN Ethernet interface, a WAN Ethernet interface, a SCSI interface, a serial interface, an USB interface, and the like.

The authentication server 104 is configured to verify the authentication input 108 and the additional authentication credential 110 provided by the user 102. The authentication server 104 may be connected to rest of the network environment 100 via one of a wired connection (e.g., LAN, WAN) or a wireless connection (e.g., cellular, WiFi, Ultrawideband). In turn, the authentication server 104 may provide one or more access tokens 118 to the user 102 based on the authentication inputs 108 and additional authentication credential 110.

In various embodiments, the access tokens 118 may include Kerberos ticket granting tickets (TGTs). In other embodiments, the access tokens 118 may include authorization tokens, service tokens, or Security Assertion Markup Language (SAML) tokens, etc.

The user 102 may use one or more access tokens 118 to access one or more networked resources on the target server 120. The target server 120 may be a Windows® operating system-based target server, a Linux server, and the like. In one instance, the user 102 may submit a resource access request 122, along with one or more access tokens 118, to the target server 120. As described herein, a network resource is any resource provided by one or more computing devices in a computing environment. For instance, networked resources may include an operating system, a mail server, a file store, a web server, a gateway server, an application program, a messaging application, a collaboration application, a calendar application, a print service, and virtually any other type of computing data, device, or service.

In turn, the target server 120 may validate the access tokens 118 using an authorization policy. In various embodiments, the target server 120 may compare the one or more access tokens 118 against an authorization policy that is stored within the server. Alternatively, the target server 120 may validate the one or more access tokens 118 against an authorization policy that the target server 120 accesses from a policy server 124.

In one embodiment, if the one or more access tokens 118 indicate that the user 102 is permitted to access the one or more desired networked resources and/or perform certain tasks on the target server 120, the user 102 may be given rights to perform the tasks and/or granted access to those networked resources. On the other hand, if the one or more access tokens 118 do not permit the user 102 to access the desired networked resources, the user may be denied rights and/or access. The target server 120 may relay the access/permission decision, that is, the grant or denial of access/permission, to the user 102 via the client PC 106.

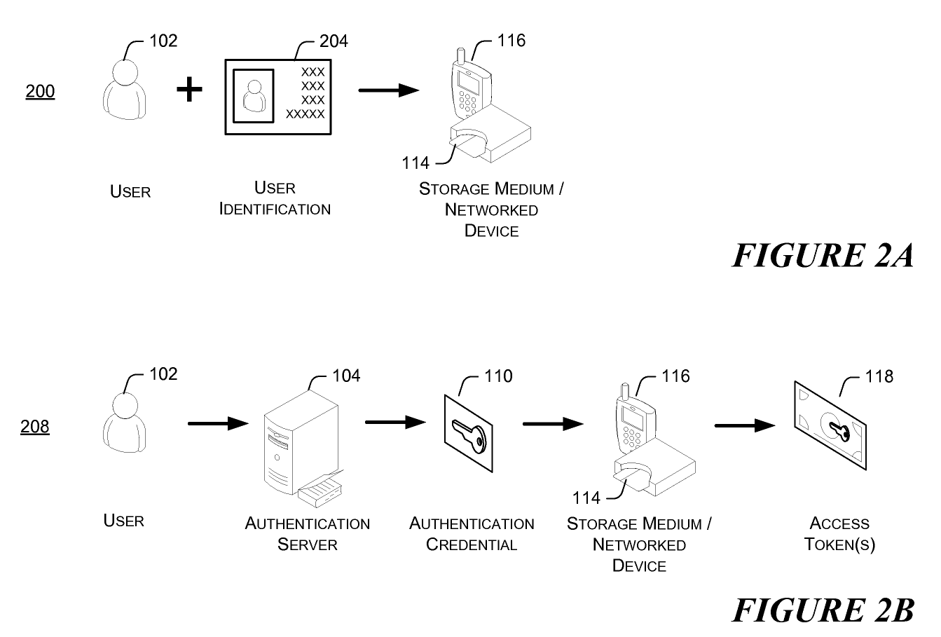

FIG. 2A is a block diagram illustrating an exemplary procedure 200 for issuing a networked device 116 that is capable of storing the one or more authentication credentials 110 as encrypted data to a user. For example, the exemplary procedure 200 may be initiated when a user 102 provides identification 204 to an issuing authority. The issuing authority may be an entity that controls the authentication server 104. The user identification 204 may be any documentation or characteristic which serves to verify the identity of the user 102. For example, the user identification 204 may be a government-issued photographic identification, an employer-issued identification, a pre-stored biometric characteristic, or other similar documentation or characteristic.

In exchange for the identification, the issuing authority may provide the user 102 with a data storage medium 114 (FIG. 1) that is capable of encrypting data. The data storage medium 114 may be further integrated into a networked device 116 (FIG. 1). For example, but not limiting, the issuing authority may provide the user 102 with a SD card that includes the Cryptomeria cipher (C2) algorithm. The user 102 may then install the SD card into a networked device 116, such as a wireless communication device, that is capable of interacting with the SD card.

In additional embodiments, the user 102 may be issued with a networked device 116 that includes built-in data storage and a data encryption algorithm. The algorithm may include the C2 algorithm. In some embodiments, the issuing authority may record an identification characteristic of the networked device 116 during the provision of the networked device 116. For instance, the identification characteristics may include the card identifiers of SD cards, and/or device identifiers of wireless communication devices.

FIG. 2B is a block diagram illustration an exemplary procedure 208 for providing the networked device 116 (FIG. 1) with authentication credentials 110. The encrypted authentication credentials 110 are stored as encrypted data in the networked device 116. Subsequently, the user 102 may use the encrypted data to obtain one or more access tokens, such as the access tokens 118.

In the exemplary procedure 208, the user 102 may initially logon to the authentication server 104 using a pre-established logon identity and password. Once the authentication server 104 has recognized the logon identity and password as valid, the server may prompt the user to provide the networked device 116 for interaction with the server. When the networked device 116 is in communication with the authentication server 104, the server may load the authentication credential 110 (FIG. 1) into the networked device 116, and/or the data storage medium 114 (FIG. 1) in the device. The networked device 116 may further encrypt the authentication credentials 110 using an encryption algorithm, such as the C2 algorithm. The encryption of the authentication credentials 110 may prevent the credentials from being duplicated or modified. In subsequent exemplary attempts to access computing resources, the user 102 may employ strong authentication by submitting the authentication credential 110 in conjunction with the logon identity and password. In turn, the authentication server 104 may provide the user 102 with one or more access tokens 118 (FIG. 1).

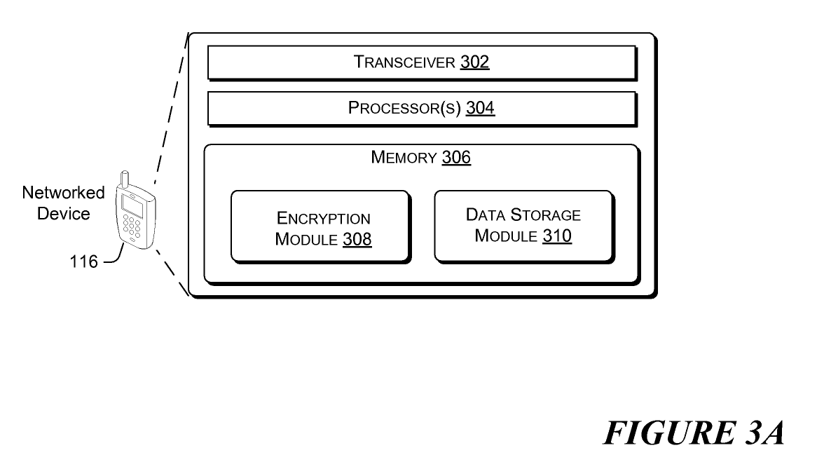

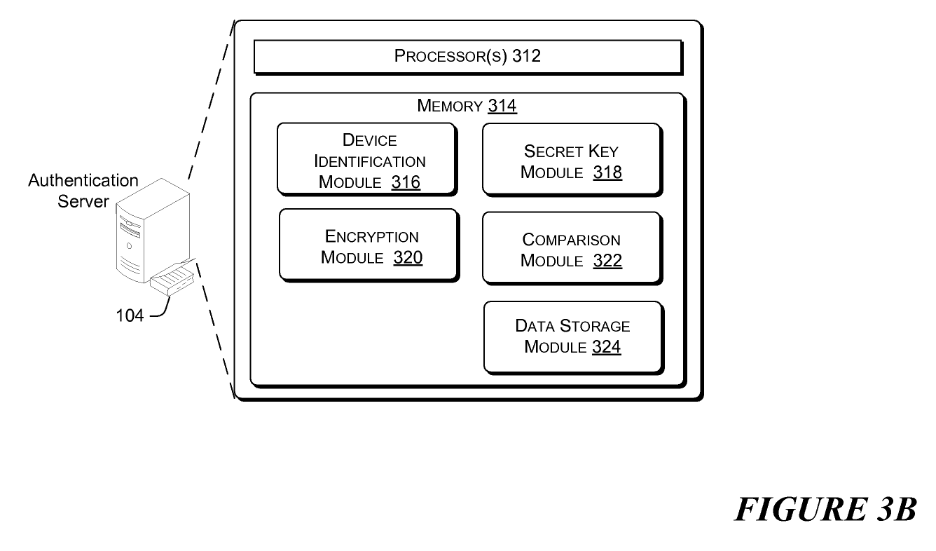

FIG. 3A illustrates selected components of an exemplary networked device 116 that is capable of data encryption, in accordance with various embodiments. The exemplary networked device 116 may include a transceiver 302, one or more processors 304 and a memory 306. The transceiver 302 may be coupled to a wireless interface and/or a wired interface (not shown). The wireless interface may include, but is not limited to, a wireless RF interface (e.g. cellular, PCS, WiFi, Ultrawideband, Bluetooth, satellite transmissions, RFID, etc.), an infrared interface, and the like. The wired interface may include a direct I/O interface, such as a SCSI interface, a serial interface, a USB interface, and the like. The transceiver 202, in conjunction with interfaces, may enable the networked device 104 to connect with servers, communicate with other computing devices, as well as transmit and/or receive data such as Internet web pages, messages, “computer cookies,” or other small data files.

The memory 306 may include volatile and/or nonvolatile memory, removable and non-removable media implemented in any method or technology for storage of information, such as computer-readable instructions, data structures, program modules or other data. Such memory may include, but is not limited to, random access memory (RAM), read-only memory (ROM), Electrically erasable programmable read-only Memory (EEPROM), flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system. In some embodiments, the memory 306 may be the removable memory included in a Secure Digital (SD) card. In other embodiments, the memory 306 may be RAM built into the networked device 116, or a combination of both.

The memory 306 of the networked device 116 may store program instructions. The program instructions, or modules, may include routines, programs, objects, components, and data structures that perform particular tasks or implement particular abstract data types. The modules may be implemented as software or computer-executable instructions that are executed by one or more processors 302. The modules may include an encryption module 308, and a data storage module 210. The encryption module 302 may be configured to encrypt and decrypt data using an encryption algorithm. In various embodiments, the encryption algorithm may include the Cryptomeria cipher (C2) algorithm. The encryption module 302 may be configured encrypt or decrypt data using an encryption key. The encryption key being a parameter that determines the functional output of the encryption algorithm.

The data storage module 310 may be configured to store data in a portion of memory 306 (e.g., a database). In various embodiments, the data storage module 310 may be configured to store the data that are decrypted or encrypted by the encryption module 308. The data storage module 310 may also store additional data such as application configuration settings, operating system settings, identification information, and other data used by the networked device 116 and/or memory 306. For example, in instances where the memory 306 includes an SD card memory, the identity of the SD card may be stored in the memory 306.

FIG. 3B illustrates selected components of an exemplary authentication server 104. The exemplary authentication server 104 may include computer-program instructions being executed by a computing device, such as the computing environment 900 described in FIG. 9. The authentication server 104 may include one or more processors 312 and memory 314. The memory 314 may include volatile and/or nonvolatile memory, removable and non-removable media implemented in any method or technology for storage of information, such as computer-readable instructions, data structures, program modules or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and is accessible by a computer system.

The memory 314 of the authentication server 104 may store program instructions. The program instructions, or modules, may include routines, programs, objects, components, and data structures that perform particular tasks or implement particular abstract data types. The modules may be implemented as software or computer-executable instructions that are executed by one or more processors 312. The modules may include a device identification module 316, a secret key module 318, an encryption module 320, a comparison module 322, and a data storage module 324. However, one of ordinary skill in the art will further appreciate that exemplary authentication server 104 may include other components that provide authentication services to users or other systems. Furthermore, the selected modules shown in example authentication server 104 may be provided in various combinations thereof.

The device identification module 316 may be configured to identify a networked device by the authentication input that a user 102 submits when the networked device is connected to the authentication server 104. For example, the user 102 may submit a logon identity and password on a remote terminal, such as remote terminal 106, while simultaneously connecting a networked device, such as networked device 116, to the authentication server 104 via an authentication input interface, such as authentication input interface 110. The authentication input interface being attached to the same remote terminal. Accordingly, the device identification module 316 may automatically associate the connected networked device with the user 102. In some instances, the device identification module 316 may further store the association information in a portion of the memory 314 using data storage module 324.

In some embodiments, the device identification module 316 may extract a unique identifier from the networked device during the association between the networked device and the user 102. For example, in instances where the networked device is a wireless communication device, the device identification module 316 may be configured to record and/or verify the identity of the wireless communication device by obtaining the Mobile Identification Number (MIN) or the electronic serial number (ESN) of the device. In other instances, the device identification module 316 may obtain the card identification number (CIN) of a SD card that is associated with the networked device to identify the networked device.

The secret key module 318 may be configured to generate a unique secret key to pass to each networked device, such as the networked device 116. In turn, the generated secret key may be employed by the encryption module 308 of the networked device 116 to encrypt data. In other words, the networked device 116 may use the secret key as an encryption key. Furthermore, the secret key module 318 may generate information that associates a generated unique secret key with a particular networked device, the particular networked device being further associated with a user. The secret key module 218 may further instruct the data storage module 324 to store this information in a portion of the memory 314.

The encryption module 320 may be configured to encrypt and decrypt data using an encryption algorithm. In various embodiments, the encryption algorithm may include the Cryptomeria cipher (C2) algorithm. The encryption module 316 may be configured to encrypt data before they are transmitted to the networked device 116. The encryption module 318 may be configured encrypt or decrypt data using an encryption key. The encryption key being a parameter that determines the functional output of the encryption algorithm.

The comparison module 322 may be configured to compare data for the purpose of enabling to authentication server 104 to grant access to computer resources. For example, the comparison module 322 may compare a first secret key that is generated for a particular networked device to a second secret key that is received from the particular networked device during an authentication process. According to various embodiments, if the two secret keys match, the comparison module 322 may cause the authentication server 104 to generate an access token, such as an access token 118 (FIG. 1), for the particular networked device. The user of the particular networked device is then able to use the access token to access computing resources. For example, as described above, the user may be able to access computing resources on the target server 120 (FIG. 1).

The data storage module 324 may be configured to store data in a portion of memory 314 (e.g., a database). In various embodiments, the data storage module 324 may be configured to store the data that are decrypted or encrypted by the encryption module 318. Moreover, as described above, the data storage module 324 may also store information that associates a specific networked device with a particular user, and/or a particular secret key.

### Exemplary Processes

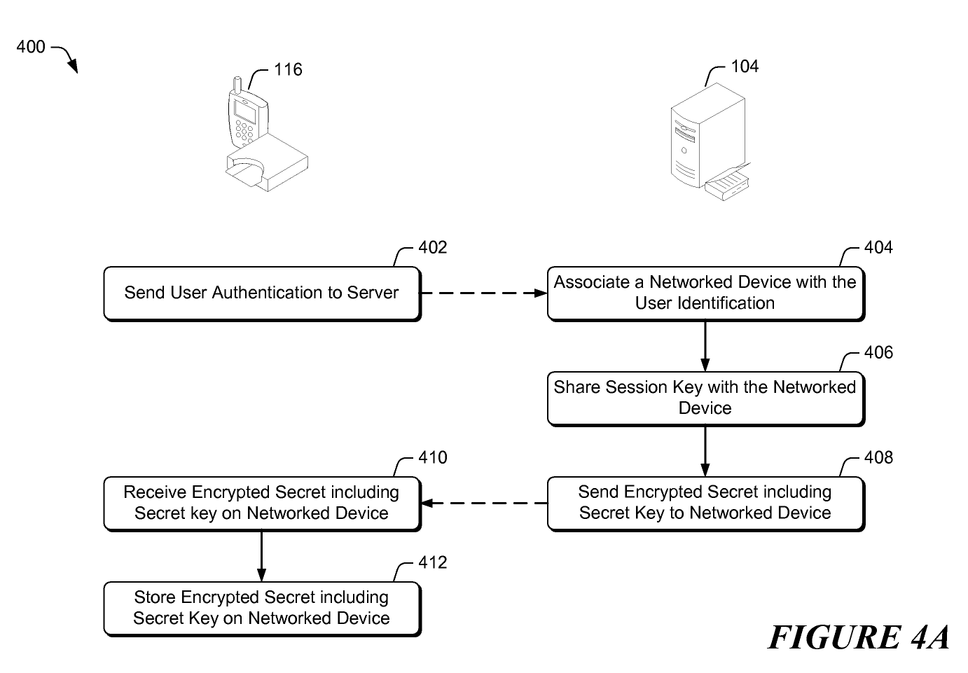

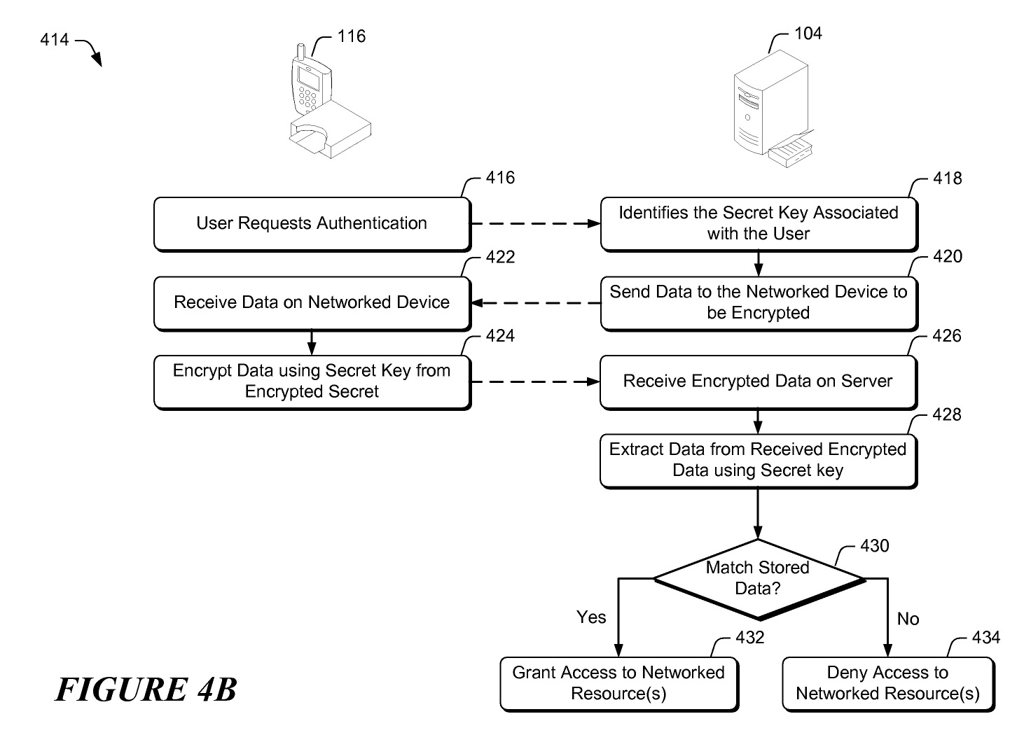

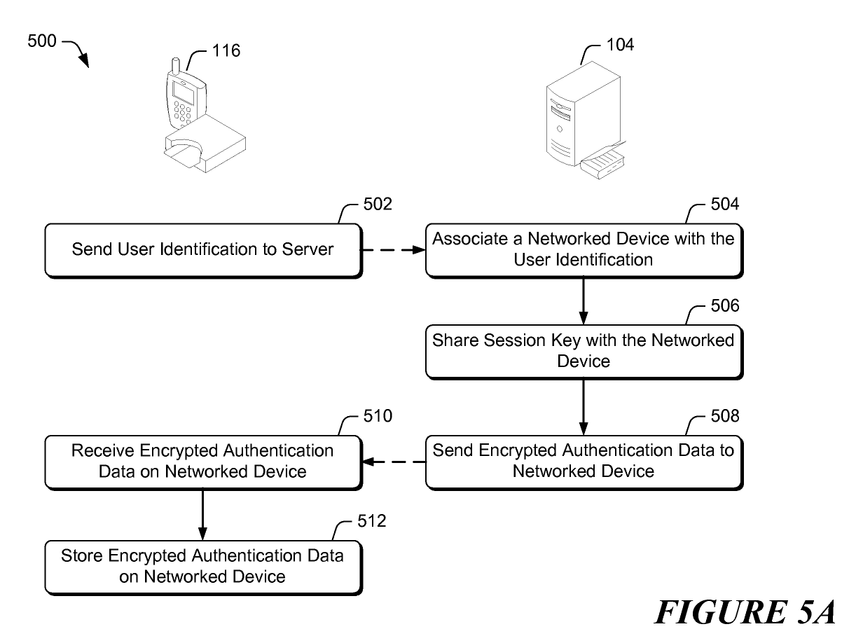

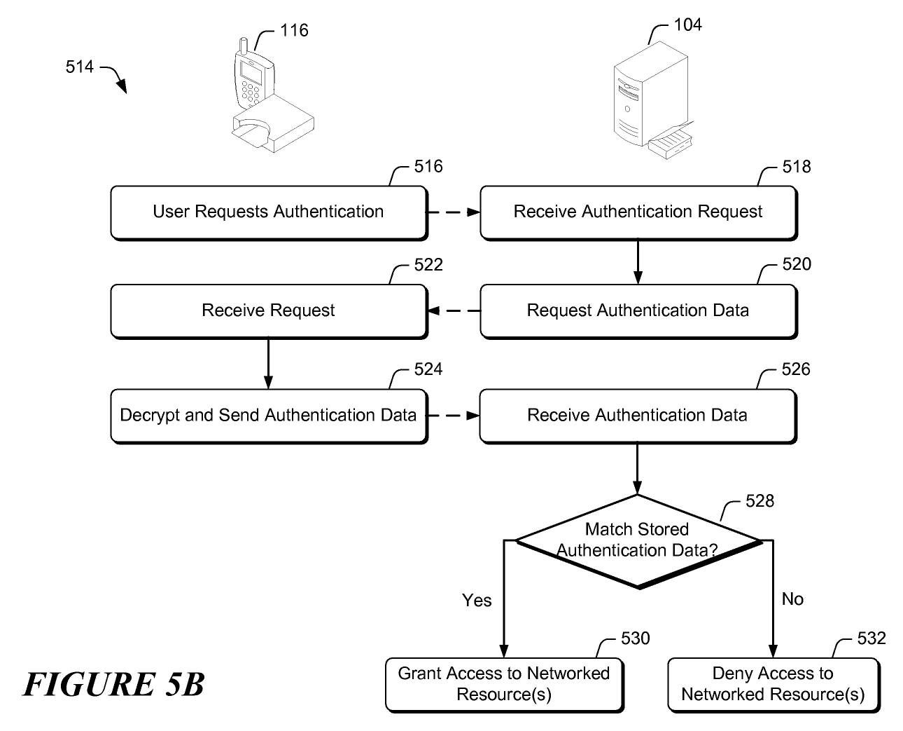

FIGS. 4A-4B and 5A-5B illustrate exemplary processes that facilitate strong authentication to networked resources, in accordance with various embodiments. The exemplary processes in FIGS. 4A-4B and 5A-5B are illustrated as a collection of blocks in a logical flow diagram, which represents a sequence of operations that can be implemented in hardware, software, and a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. The order in which the operations are presently described is not intended to be construed as a limitation, and any number of the described blocks can be combined in any order and/or in parallel to implement the process. For discussion purposes, the processes are described with reference to the exemplary network environment 100 of FIG. 1, although they may be implemented in other system architectures.

FIG. 4A is a block diagram illustrating an exemplary process 400 for storing an encrypted secret on an encryption algorithm-equipped networked device, in accordance with various embodiments. The exemplary process 400 may include steps that are implemented on a networked device, such as the networked device 116, as well as steps that are implemented on an authentication server, such as the authentication server 104. The networked device 116 may be one of a wireless communication device that includes a built-in encryption algorithm, a USB dongle that includes an SD card, a wireless communication device that includes a SD card, or the like.

At block 402, a user 102 may send a user authentication to an authentication server 104 to setup a networked device 116 for use in a strong authentication process. The user authentication may include a pre-established logon identity and/or password. Further, the user 102 may send the authentication using a client PC, such as the client PC 106. Alternatively, the user may also send the user authentication to the authentication server 104 via the networked device 116.

At block 404, the authentication sever 104 may associate the networked device 116 with the user authentication submitted by the user 102. In various embodiments, the authentication server 104 may cause the client PC 106 to prompt the user to establish a communication connection between the networked device 116 and the authentication server 104. The communication connection may be established via an authentication input interface 112 that is connected to the client PC 106, such as via a wireless connection and/or a wired connection.

Once the authentication server 104 is connected to the networked device 116, the authentication server 104 may challenge the networked device 116 to ensure that it is a valid device. For instance, the authentication server 104 may request that the networked device 116 perform a mathematical calculation to ensure that the device has the necessary processing capability. In other instances, the authentication server 104 may also obtain information from the networked device 116 to verify that it is one or more of the correct type, e.g., compatible with a particular operating system, includes a compatible data storage format, and the like. In additional instances, the authentication server 104 may also extract a unique identifier (e.g., mobile identification number, SD card identification number, etc.) from the networked device during the challenge process and store it in a database on the authentication server 104.

Likewise, the networked device 116 may also challenge the authentication server 104 at block 404. For example, the networked device 116 may request information from the authentication server 104 that indicates the server is one or more of the correct type, e.g., compatible with a particular operating system, includes a compatible data storage format, and the like. Once the mutual challenge process is completed, the process 400 may proceed to block 406. Otherwise, the networked device 116 will not associate with the authentication server 104.

At block 406, the authentication server 104 may share a session key with the networked device 116. In accordance with various embodiments, the session key is a symmetric key used for encrypting data. Upon receiving the session key, the networked device 116 may stored the session key in a memory portion of the networked device 116, such as in the memory 306 (FIG. 3A). At block 408, the authentication server 104 may further send an encrypted secret to the networked device 116. The encrypted secret may be encrypted by an encryption algorithm based on the session key. According to various embodiments, the encryption algorithm may include the Cryptomeria cipher (C2) algorithm. However, in other embodiments, the secret may be encrypted based on the session key using another encryption algorithm. The encrypted secret may include a secret key. The secret key, in turn, may be further used for the encryption of additional data by an encryption algorithm. Additionally, as describe above, the authentication server 104 may store the secret key in a memory portion of the authentication server 104, such as a database in the memory 314 (FIG. 3B).

At block 410, the encrypted secret that includes the secret key may be received by the networked device 116 via the wireless connection and/or the wired connection. At block 412, the networked device 116 may store the encrypted secret in a memory portion of the networked device 116, such as a database in the memory 306 (FIG. 3A).

FIG. 4B is a flow diagram illustrating an exemplary process 414 for authentication to access networked resources using an encrypted secret, in accordance with various embodiments. The exemplary process 414 may include steps that are implemented on a networked device, such as the networked device 116, as well as steps that are implemented on an authentication server, such as the authentication server 104. As described above, the encrypted secret is provided to networked device 116 by the authentication server 104 during process 400.

At block 416, a user 102 may request authentication to the authentication server 104. The user 102 may request authentication from a client PC 106 that is connected to the authentication server 104. During the authentication process, the user may submit a user authentication that includes a pre-established logon identity and/or password. At block 418, the authentication server 104 may identify the secret key that is associated with the user, and in turn, the networked device 116 that is associated with the user 102, based on the submitted user authentication. For example, the authentication server 104 may identify the secret key for the user 102 using association information stored in a database, such as a database in the memory 314 (FIG. 3B).

At block 420, the authentication server 104 may send data (“original data”) to the networked device 116 to be encrypted. The data may be in any form as long as it capable of being encrypted by an encryption algorithm (e.g., alphanumerical values, symbols, etc.). For example, the data may be a current time value on the authentication server 104. Prior to sending the data, the authentication server 104 may record the data, as well as associate the data with the identity of the networked device 116. The authentication server 104 may also store the data and the association information in a database, such as a database in the memory 314. At block 422, the data to be encrypted may be received by the networked device 116 via a network connection. The network connection may include a wired network connection and/or a wireless network connection. For example, the networked device 116 may receive the data via the authentication input interface 110 that is attached to the client PC 106 (FIG. 1).

At block 424, the networked device 116 may use a secret key to encrypt the data. In various embodiments, the secret key may be the key that the networked device 116 received from the authentication server 104 in the block 410 of the process 400. In such embodiments, the networked device 116 may decrypt the secret key from the encrypted secret using the encryption algorithm described in process 400 (e.g., Cryptomeria cipher “C2” algorithm) based on the session key. Once the secret key is decrypted, the networked device 116 may use an encryption algorithm to encrypt the data based on the secret key. In some embodiments, the encryption algorithm may be the C2 algorithm.

At block 426, the encrypted data from block 424 may be received by the authentication server 104 via the network connection. At block 428, the authentication serve 104 may decrypt the encrypted data using the same algorithm employed by the networked device 116 at the block 424. For instance, the authentication server 104 may use the C2 algorithm. Additionally, the decryption of the encrypted data may be implemented using the secret key stored in the authentication server 104 and provided to the networked device 116 at block 410 of the process 400. As described in process 400, the authentication server 104 may have stored the secret key in a database residing in the memory 314.

At decision block 430, the authentication server 104 may determine whether the decrypted data from the block 428 matches the original data that was sent to the networked device 116 at the block 420. If the authentication server 104 determines that the decrypted data matches the original data (“yes” at decision block 430), the process 400 may proceed to block 432. At block 432, the authentication server 104 may grant the networked device 116 access to networked resources. In various instances, the networked resources may reside on the authentication server 104. In other instances, the networked resources may reside on a server that is connected to the same network as the authentication server 104. According to various embodiments, the authentication server 104 may grant such access to the user 102 by providing the networked device 116 with an access token.

However, if the authentication server 104 determines that the decrypted data does not match the original data (“no” at the decision block 430), the process 400 may proceed to block 434. At block 434, the authentication server 104 may deny the networked device 116 access to networked resources.

FIG. 5A is a block diagram illustrating an exemplary process 500 for storing authentication data on an encryption algorithm-equipped networked device, in accordance with various embodiments. The exemplary process 500 may include steps that are implemented on a networked device, such as the networked device 116, as well as steps that are implemented on an authentication server, such as the authentication server 104. The networked device 116 may be one of a wireless communication device that includes a built-in encryption algorithm, a USB dongle that includes an SD card, a wireless communication device that includes a SD card, or the like.

At block 502, a user 102 may send a user authentication to an authentication server 104 to set up a networked device for use in a strong authentication process. The user authentication may include a pre-established logon identity and/or password. Further, the user 102 may send the authentication using a client PC, such as the client PC 106. Alternatively, the user may also send the user authentication to the authentication server 104 via the networked device 116.

At block 504, the authentication sever 104 may associate the networked device 116 with the user authentication submitted by the user 102. In various embodiments, the authentication server 104 may cause the client PC 106 to prompt the user to establish a communication connection between the networked device 116 and the authentication server. The communication connection may be established via an authentication input interface 110 that is connected to the client PC 106, such as via a wireless connection and/or a wired connection.

Once the authentication server 104 is connected to the networked device 116, the authentication server 104 may challenge the networked device 116 to ensure that it is a valid device. For instance, the authentication server 104 may request that the networked device 116 perform a mathematical calculation to ensure that the device has the necessary processing capability. In other instances, the authentication server 104 may also obtain information from the networked device 116 to verify that it is one or more of the correct type, e.g., compatible with a particular operating system, includes a compatible data storage format, and the like. In additional instances, the authentication server 104 may also extract a unique identifier (e.g., mobile identification number, SD card identification number, etc.) from the networked device during the challenge process and store it in a database on the authentication server 104.

Likewise, the networked device 116 may also challenge the authentication server 104 at block 504. For example, the networked device 116 may request information from the authentication server 104 that indicates the server is one or more of the correct type, e.g., compatible with a particular operating system, includes a compatible data storage format, and the like. Once the mutual challenge process is completed, the process 500 may proceed to block 506. Otherwise, the networked device 116 is not associated with the authentication server 104.

At block 506, the authentication server 104 may share a session key with the networked device 116. In accordance with various embodiments, the session key is a symmetric key used for encrypting data. Upon receiving the session key, the networked device 116 may store the session key in a memory portion of the networked device 116, such as in the memory 306 (FIG. 3A).

At block 508, the authentication server 104 may further send encrypted authentication data to the networked device 116. The encrypted authentication data may be encrypted by an encryption algorithm based on the session key. According to various embodiments, the encryption algorithm may include the Cryptomeria cipher (C2) algorithm. However, in other embodiments, the authentication data may be encrypted based on the session key using another encryption algorithm. The encrypted authentication data may include, but is not limited to, an authentication certificate with corresponding key pairs, such as those associated with smart card-based PKI authentication, as well as a list of one-time passwords. Additionally, as describe above, the authentication server 104 may store the authentication data in a memory portion of the authentication server 104, such as a database in the memory 314 (FIG. 3B).

At block 510, the encrypted authentication data may be received by the networked device 116 via the wireless connection and/or wired connection. At block 512, the networked device 116 may store the encrypted authentication data in a memory portion of the networked device 116, such as the memory 306 (FIG. 3A).

FIG. 5B is a flow diagram illustrating an exemplary process 514 for authenticating to networked resources using encrypted authentication data, in accordance with various embodiments. The exemplary process 514 may include steps that are implemented on a networked device, such as the networked device 116, as well as steps that are implemented on an authentication server, such as the authentication server 104. As described above, the encrypted authentication is provided to networked device 116 by the authentication server 104 during process 500.

At block 516, a user 102 may request authentication to the authentication server 104. The user 102 may request authentication from a client PC 106 that is connected to the authentication server 104. In instances where the authentication data includes an authentication certificate and corresponding key pairs, the user may submit a user authentication that includes a pre-established logon identity and/or password during the authentication process. In this way, two-factor authentication may be implemented. In other instances, the user authentication may include a logon identity.

At block 518, the authentication server 104 may receive the authentication request via a network connection. The network connection may include a wired network connection and/or a wireless network connection. At block 520, the authentication server 520 may request the authentication data from the networked device 116. For instance, the authentication server 104 may request a password from a one-time password list, or a message that includes a key from a key pair, such as from a Smartcard PKI authentication key pair. At block 522, the networked device 116 may receive the request for the authentication data. At block 524, the networked device 116 may decrypt the necessary authentication data and transmit the authentication data to the authentication server 104. In various embodiments, the networked device 116 may decrypt the authentication data using the encryption algorithm described in process 500 (e.g., Cryptomeria cipher “C2” algorithm) based on the session key. In some embodiments, the encryption algorithm may be the C2 algorithm.

At block 526, the authentication data from block 524 may be received by the authentication server 104 via the network connection. At decision block 528, the authentication server 104 may determine whether the received authentication data from the block 526 matches the original authentication data that was sent to the networked device 116 at the block 510 (FIG. 5A). If the authentication server 104 determines that the decrypted data matches the original data (“yes” at decision block 528), the process 500 may proceed to block 530. For example, if the one-time password provided by the networked device 116 is identical to the sequentially correct one-time password from the password list in the authentication server 104, then the server may determine a match occurred. In another example, the authentication server 104 that is performing a Kerberos authentication process may determine whether a match occurred based on authentication data in the form of a key. In such an example, a match is deemed to have occurred when the key is identical to a key from a key pair associated with an authentication certificate previously provided to the networked device 116.

At block 530, the authentication server 104 may grant the networked device 116 access to networked resources. In various instances, the networked resources may reside on the authentication server 104. In other instances, the networked resources may reside on a server that is connected to the same network as the authentication server 104. According to various embodiments, the authentication server 104 may grant such access to the user 102 by providing the networked device 116 with an access token.

However, if the authentication server 104 determines that the decrypted data does not match the original data (“no” at the decision block 528), the process 500 may proceed to block 532. At block 532, the authentication server 104 may deny the networked device 116 access to networked resources.

### Exemplary Computing Environment

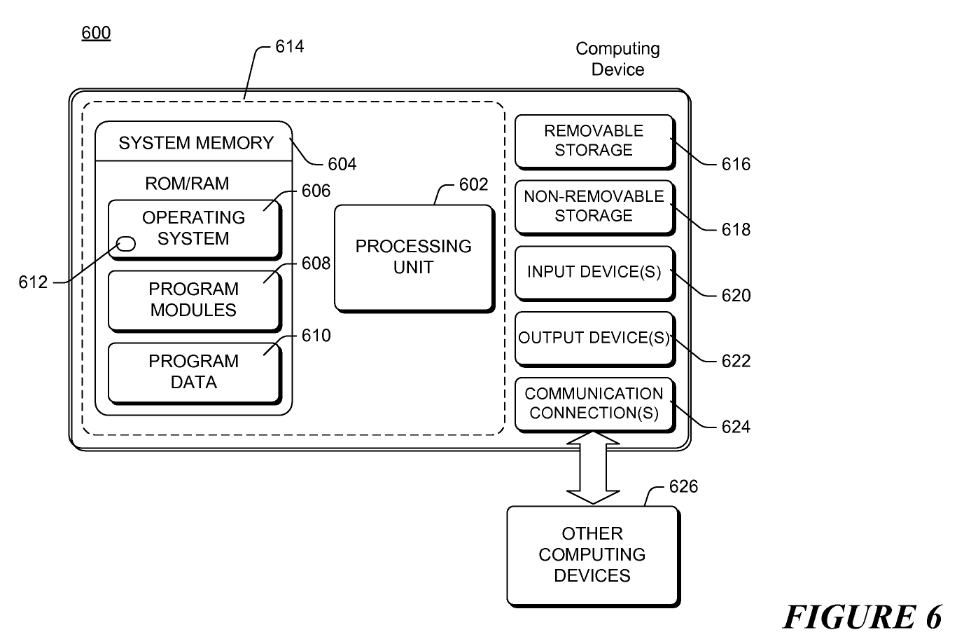

FIG. 6 illustrates a representative computing device 600 that may be used to implement the selective networked resource access techniques and mechanisms described herein. For example, the authentication server 104 (FIG. 1) may be implemented on the representative computing device 600. However, it will readily be appreciated that the various embodiments of the selective networked resource techniques and mechanisms may be implemented in other computing devices, systems, and environments. The computing device 600 shown in FIG. 6 is only one example of a computing device, and is not intended to suggest any limitation as to the scope of use or functionality of the computer and network architectures. Neither should the computing device 600 be interpreted as having any dependency or requirement relating to any one or combination of components illustrated in the example computing device.

In a very basic configuration, computing device 600 typically includes at least one processing unit 602 and system memory 604. Depending on the exact configuration and type of computing device, system memory 604 may be volatile (such as RAM), non-volatile (such as ROM, flash memory, etc.) or some combination of the two. System memory 604 typically includes an operating system 606, one or more program modules 608, and may include program data 610. The operating system 606 includes a component-based framework 612 that supports components (including properties and events), objects, inheritance, polymorphism, reflection, and provides an object-oriented component-based application programming interface (API), such as, but by no means limited to, that of the .NET™ Framework manufactured by the Microsoft Corporation, Redmond, Wash. The device 600 is of a very basic configuration demarcated by a dashed line 614. Again, a terminal may have fewer components but will interact with a computing device that may have such a basic configuration.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by removable storage 616 and non-removable storage 618. Computer storage media may include volatile and nonvolatile, removable and non-removable media implemented in any method or technology for storage of information, such as computer readable instructions, data structures, program modules, or other data. System memory 604, removable storage 616 and non-removable storage 618 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of device 600. Computing device 600 may also have input device(s) 620 such as keyboard, mouse, pen, voice input device, touch input device, etc. Output device(s) 622 such as a display, speakers, printer, etc. may also be included. These devices are well known in the art and are not discussed at length here.

Computing device 600 may also contain communication connections 624 that allow the device to communicate with other computing devices 626, such as over a network. These networks may include wired networks as well as wireless networks. Communication connections 624 are some examples of communication media. Communication media may typically be embodied by computer readable instructions, data structures, program modules, etc.

It is appreciated that the illustrated computing device 600 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

The encryption of strong authentication data stored on a networked device, such as encryption using a Cryptomeria cipher algorithm, may enhance security. The encryption may prevent the authentication data from being duplicated or modified. This enhanced security may be especially important for the protection of high end, valuable, expensive or sensitive resources, applications or data. Thus, embodiments in accordance with this disclosure may serve to ensure that only the intended authorized and properly authenticated entities access these resources.

### Conclusion

In closing, although the various embodiments have been described in language specific to structural features and/or methodological acts, it is to be understood that the subject matter defined in the appended representations is not necessarily limited to the specific features or acts described. Rather, the specific features and acts are disclosed as exemplary forms of implementing the claimed subject matter.

1. A method for authentication to a server, comprising:
associating a networked device with a user identification submitted to the server;
sharing a session key between the networked device and the server; and
sending an encrypted secret that is encoded based on the session key to a memory of the networked device, the encrypted secret including a secret key associated with the networked device and stored on the server,
the networked device being configured to decrypt the secret key from the encrypted secret using the session key.

2. The method of claim 1, further comprising:
identifying the secret key corresponding to the networked device during a user authentication to the server;
sending original data to the networked device for encryption into encrypted data using the secret key that is included in the encrypted secret;
decrypting the encrypted data received from the networked device using the secret key to obtain decrypted data; and
providing access to a networked resource when the decrypted data matches the original data.

3. The method of claim 1, wherein the networked device is a wireless communication device.

4. The method of claim 1, wherein sending an encrypted secret to a memory of the networked device includes sending the encrypted secret to a secure digital (SD) card memory of the wireless communication device.

5. The method of claim 1, further comprising generating the encrypted secret using a first algorithm that is identical to a second algorithm stored on the networked device.

6. The method of claim 1, further comprising generating the encrypted secret using a first algorithm that is identical to a second algorithm stored on the networked device, wherein the networked device is further configured to decrypt the copy secret key from the encrypted secret using the second algorithm.

7. The method of claim 1, further comprising generating the encrypted secret using a first algorithm that is identical to a second algorithm stored on the networked device, each of the first and second algorithms being a Cryptomeria cipher (C2) algorithm.

8. The method of claim 2, wherein the user identification includes at least one of a user identity and passphrase, and wherein identifying the networked device includes identifying the networked device based on the user identification.

9. The method of claim 2, wherein the networked resource includes at least one of an operating system, an application, or a service on a resource server.

10. The method of claim 2, wherein providing access to a networked resource includes assigning an access token to a user of the networked device.

11. A computer readable medium storing computer-executable instructions that, when executed, cause one or more processors to perform acts comprising:
associating a networked device with a user identification;
correlating the networked device with authentication data stored in a server;
sending a copy of the authentication data to the networked device for encryption by the networked device into secured data;
storing the secured data in the networked device;
identifying the networked device during a user authentication to the server;
receiving the copy of the authentication data from the networked device, the authentication data being decrypted from the secured data by the networked device; and
providing access to a networked resource if the copy of the authentication data matches the authentication data stored on the server.

12. The computer readable medium of claim 11, wherein the authentication data includes an authentication certificate and a key pair.

13. The computer readable medium of claim 11, wherein the authentication data includes a password in a list of one-time use passwords.

14. The computer readable medium of claim 11, wherein the networked device is a wireless communication device, and the storing the secured data includes storing the secured data in a secure digital (SD) card memory of the wireless communication device.

15. The computer readable medium of claim 11, wherein the networked resource includes at least one of an operating system, an application, or a service on a resource server, and wherein the providing access to a networked resource includes assigning an access token to a user of the networked device.

16. The computer readable medium of claim 11, wherein the sending a copy of the authentication data to the networked device for encryption includes sending a copy of the authentication data for encryption by a Cryptomeria cipher (C2) algorithm stored in the networked device.

17. A computer readable medium storing computer-executable instructions that, when executed, cause one or more processors to perform acts comprising:
associating a networked device with a user identification submitted to the server;
sharing a session key between the networked device and the server; and
sending an encrypted secret that is encoded based on the session key to a memory of the networked device, the encrypted secret including a secret key associated with the networked device and stored on the server, the networked device being configured to decrypt the secret key from the encrypted secret using the session key;
identifying the networked device during a user authentication to the server;
sending original data to the networked device for encryption into encrypted data using the secret key that is included in the encrypted secret;
decrypting the encrypted data received from the networked device using the secret key to obtain decrypted data; and
providing access to a networked resource when the decrypted data matches the original data.

18. The computer readable medium of claim 17, further comprising generating the encrypted secret using a first algorithm that is identical to a second algorithm stored on the networked device, each of the first and second algorithms being a Cryptomeria cipher (C2) algorithm.

19. The computer readable medium of claim 17, wherein the user identification includes at least one of a user identity and passphrase, and wherein identifying the networked device includes identifying the networked device based on the user identification.

20. The computer readable medium of claim 17, wherein sending an encrypted secret to a memory of the networked device includes sending the encrypted secret to a secure digital (SD) card memory of the wireless communication device.
